(19) United States
(12) Patent Application Publication
(10) Pub. No.: US 2005/0206856 A1
(43) Pub. Date: Sep. 22, 2005

(54) Image projection system and calibration data calculation method

(76) Inventor: Kensuke Ishii, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/031,293

(22) Filed: Jan. 7, 2005

(30) Foreign Application Priority Data
Jan. 16, 2004 (JP) 2004-009567

(51) Int. Cl. G03B 21/26

(52) U.S. Cl. 353/94

(57) ABSTRACT

An image projection system that projects a plurality of images on a screen to form a single image includes a plurality of projection units each including a plurality of light sources, a light source selection unit that selects at least one of the light sources and a display unit that is illuminated by the at least one light source selected by the light source selection unit, images that are displayed on the display units of the projection units being formed on the basis of different image data, a combination selection unit that selects a combination of the light sources that are selected by the light source selection unit, from among a plurality of predetermined combinations of the light sources included in the projection units, a storage unit that stores, in accordance with the plurality of predetermined combinations of the light sources, a plurality of calibration data that are used for adjusting illumination light amounts of the light sources and/or the images that are displayed by the display units, and a control unit that adjusts the illumination light amounts of the light sources and/or the images that are displayed by the display units, using the calibration data that corresponds to the combination of the light sources selected by the combination selection unit.

### CROSS-REFERENCE TO RELATED APPLICATIONS

This application is based upon and claims the benefit of priority from prior Japanese Patent Application No. 2004-009567, filed Jan. 16, 2004, the entire contents of which are incorporated herein by reference.

### BACKGROUND OF THE INVENTION

1. Field of the Invention

The present invention relates to an image projection system and a calibration data calculation method for use in the image projection system.

2. Description of the Related Art

In an image projection system (multi-projection system) that projects a plurality of images on a screen and forms a single image, it is necessary to make a boundary between the projected images less visible. To achieve this, an image for calibration is projected on the screen, and the projected image is captured by image capturing means such as a calibration camera. Based on the acquired image data, various corrections including geometric correction and color correction are executed (see, e.g. Jpn. Pat. Appln. KOKAI Publication No. 2002-72359).

However, in a prior-art multi-projection system, a sufficient measure has not been taken in a case where a light source for illumination malfunctions and fails to normally operate. Consequently, no image can be projected until the light source is replaced. In addition, a time is needed for acquiring calibration data once again after the replacement of the light source.

As has been described above, in the prior-art multi-projection system, no sufficient measure has been taken in the case where the light source for illumination fails to normally operate. As a result, there arises such a problem that a time period, in which a projection image cannot be displayed, occurs.

The object of the present invention is to provide an image projection system and a calibration data calculation method, which can keep proper display even in a case where a light source for illumination has become inoperable.

### BRIEF SUMMARY OF THE INVENTION

According to a first aspect of the present invention, there is provided an image projection system that projects a plurality of images on a screen to form a single image, comprising: a plurality of projection units each including a plurality of light sources, a light source selection unit that selects at least one of the light sources and a display unit that is illuminated by the at least one light source selected by the light source selection unit, images that are displayed on the display units of the projection units being formed on the basis of different image data; a combination selection unit that selects a combination of the light sources that are selected by the light source selection unit, from among a plurality of predetermined combinations of the light sources included in the projection units; a storage unit that stores, in accordance with the plurality of predetermined combinations of the light sources, a plurality of calibration data that are used for adjusting illumination light amounts of the light sources and/or the images that are displayed by the display units; and a control unit that adjusts the illumination light amounts of the light sources and/or the images that are displayed by the display units, using the calibration data that corresponds to the combination of the light sources selected by the combination selection unit.

According to a second aspect of the invention, in the image projection system, each of the projection units is composed of a single projector that includes the display unit and a plurality of the light sources, and a single image is projected on the screen from the single projector.

According to a third aspect of the invention, in the image projection system, each of the projection units is composed of a plurality of projectors each including one light source, and the plurality of projectors, which are included in each of the projection units, are configured such that images, which are based on common image data, are projected on the screen at substantially the same position on the screen.

According to a fourth aspect of the invention, in the image projection system, when two or more of the light sources can normally be turned on in each of the projection units, each of the light source selection units selects two or more light sources.

According to a fifth aspect of the invention, in the image projection system, in a case where one of the light sources, which are selected by the light source selection unit in a given one of the projection units, fails to normally operate, the control unit adjusts the image using the calibration data that corresponds to a combination of light sources, which is not selected by the combination selection unit.

According to a sixth aspect of the invention, in the image projection system, the light source selection unit in the projection unit, which is other than the given one of the projection units, does not select the light source that has light emission characteristics closest to light emission characteristics of the light source that fails to normally operate.

According to a seventh aspect of the invention, in the image projection system, the predetermined combinations of light sources include all combinations in which at least one of the light sources is turned on in each of the projection units.

According to an eighth aspect of the invention, in the image projection system, the predetermined combinations of light sources include only combinations in which the number of light sources, which are turned on, is equal between the projection units.

According to a ninth aspect of the invention, in the image projection system, the storage unit stores the calibration data such that the images that are projected on the screen by the projection units are recognized by a viewer as images with a substantially equal luminance.

According to a tenth aspect of the invention, in the image projection system, the storage unit stores the calibration data such that the number of light sources, which are turned on, is inversely proportional to the illumination light amount of each light source that is turned on.

According to an eleventh aspect of the invention, in the image projection system, the light source is composed of a lamp light source, and the control unit adjusts at least the image that is displayed by the display unit.

According to a twelfth aspect of the invention, in the image projection system, the light source is composed of an LED light source, and the control unit adjusts at least the illumination light amount of the LED light source.

According to a 13th aspect of the invention, in the image projection system, the plurality of projection units are arranged such that the images that are projected by the projection units are located adjacent to each other on the screen.

According to a 14th aspect of the invention, in the image projection system, the plurality of projection units are arranged such that the images that are located adjacent to each other on the screen partly overlap each other.

According to a 15th aspect of the invention, in the image projection system, the plurality of projection units are arranged such that the images that are projected on the screen by the projection units are shifted by half of a pixel pitch from each other.

According to a 16th aspect of the invention, in the image projection system, the calibration data includes color correction data and/or geometric correction data of the images that are projected on the screen by the projection units.

According to a 17th aspect of the invention, there is provided a calibration data calculation method in the image projection system, comprising: displaying a calibration pattern image by the display unit; turning on the light sources in accordance with each of the predetermined combinations of light sources; acquiring information relating to colors and/or geometry of the calibration pattern image that is projected on the screen by the projection unit in accordance with each of the predetermined combinations of light sources; and calculating the calibration data in accordance with each of the predetermined combinations of light sources on the basis of the acquired information.

According to an 18th aspect of the invention, there is provided a calibration data calculation method in the image projection system, comprising: displaying a calibration pattern image by the display unit; turning on the light sources in accordance with each of specified combinations of light sources, in which the number of light sources to be turned on in each of the projection units is one; acquiring information relating to colors and/or geometry of the calibration pattern image that is projected on the screen by the projection unit in accordance with each of the specified combinations of light sources; calculating the calibration data in accordance with each of the specified combinations of light sources on the basis of the acquired information; and calculating, using the calculated calibration data, calibration data with respect to the predetermined combinations other than the specified combinations.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram that shows the functional configuration of a multi-projection system according to a first embodiment of the present invention;

FIG. 2 is a view illustrating the external appearance of the multi-projection system according to the first embodiment of the invention;

FIG. 3 is a block diagram that shows an example of the structure of a multi-projection system control section in the multi-projection system shown in FIG. 1;

FIG. 4 is a block diagram that shows an example of the structure of an image display section in the multi-projection system shown in FIG. 1;

FIG. 5 is a block diagram that shows an example of the structure of an image correction data calculation section in the multi-projection system shown in FIG. 1;

FIG. 6 is a block diagram that shows an example of the structure of an image conversion section in the multi-projection system shown in FIG. 1;

FIG. 7 is a view for explaining examples of combinations of light sources in the first embodiment of the invention;

FIG. 8 is a view for explaining other examples of the combinations of light sources in the first embodiment of the invention;

FIG. 9 is a flow chart illustrating a method of calculating calibration data in the first embodiment of the invention;

FIG. 10 is a block diagram that shows the structure of the image correction data calculation section in the case of using the calibration data calculation method illustrated in FIG. 9;

FIG. 11 is a flow chart that illustrates an operation at a time of displaying content in the first embodiment of the invention;

FIG. 12 is a view illustrating the external appearance of a multi-projection system according to a second embodiment of the invention;

FIG. 13 is a block diagram that shows an example of the structure of an image display section in the multi-projection system according to the second embodiment of the invention;

FIG. 14 is a view for explaining examples of combinations of light sources and light emission amounts of the light sources in a third embodiment of the invention;

FIG. 15 is a block diagram that shows an example of the structure of an image display section in the multi-projection system according to the third embodiment of the invention;

FIG. 16 is a flow chart illustrating a calibration data calculation method in the third embodiment of the invention;

FIG. 17 is a flow chart that illustrates an operation at a time of displaying content in the third embodiment of the invention;

FIG. 18 is a view illustrating the external appearance of a multi-projection system according to a fourth embodiment of the invention;

FIG. 19 shows the state of pixel arrangements of images that are projected on the screen in the fourth embodiment of the invention;

FIG. 20A and FIG. 20B show an example of the structure of a light source according to a fourth embodiment of the invention; and

FIG. 21 is a block diagram that shows an example of the electrical configuration of the light source in the fourth embodiment of the invention.

### DETAILED DESCRIPTION OF THE INVENTION

### Embodiment 1

FIG. 1 is a block diagram that shows the functional configuration of a multi-projection system (image projection system) according to a first embodiment of the present invention.

The basic structure of this multi-projection system is the same as that of an ordinary one. The multi-projection system comprises a multi-projection system control section 10 that executes an overall system control, an image display section 20 that displays images to be projected on a screen, a calibration pattern generating section 30 that generates a calibration pattern (an image for calibration), an image capturing section 40 that captures the calibration pattern projected on the screen from the image display section 20, an image correction data calculation section 50 that calculates various image correction data (calibration data) on the basis of the captured calibration pattern, and an image conversion section 60 that corrects input image data using the calculated image correction data and generates output image data.

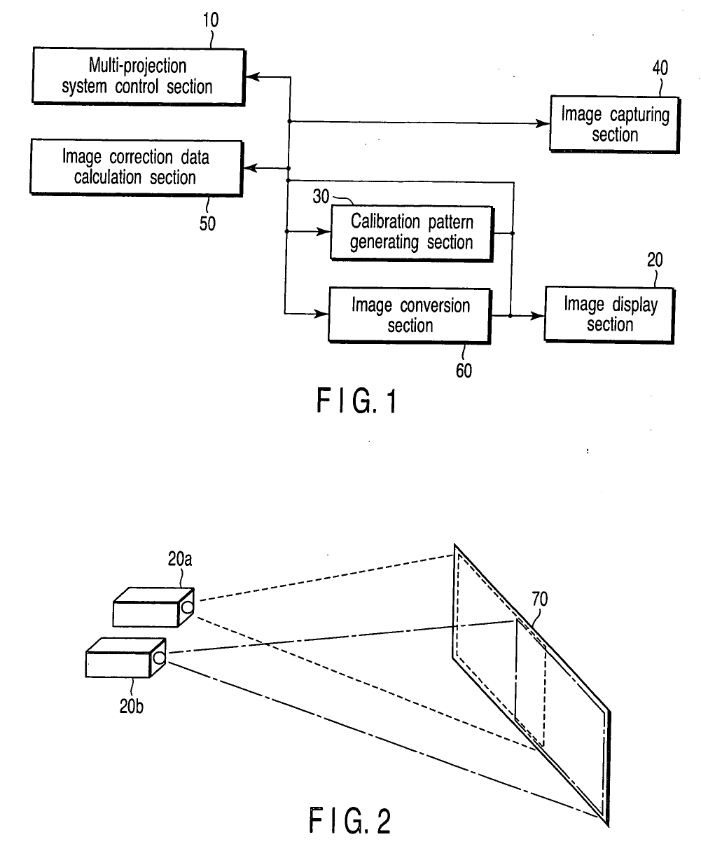

FIG. 2 is a view illustrating the external appearance of the multi-projection system according to the present embodiment. Images are projected on a screen 70 from two projection units, that is, a projector 20a and a projector 20b. A single image is formed such that the adjacent images overlap each other. The projector 20a and projector 20b are included in the image display section 20 shown in FIG. 1. In this example, two projectors are used. Alternatively, three or more projectors may be used.

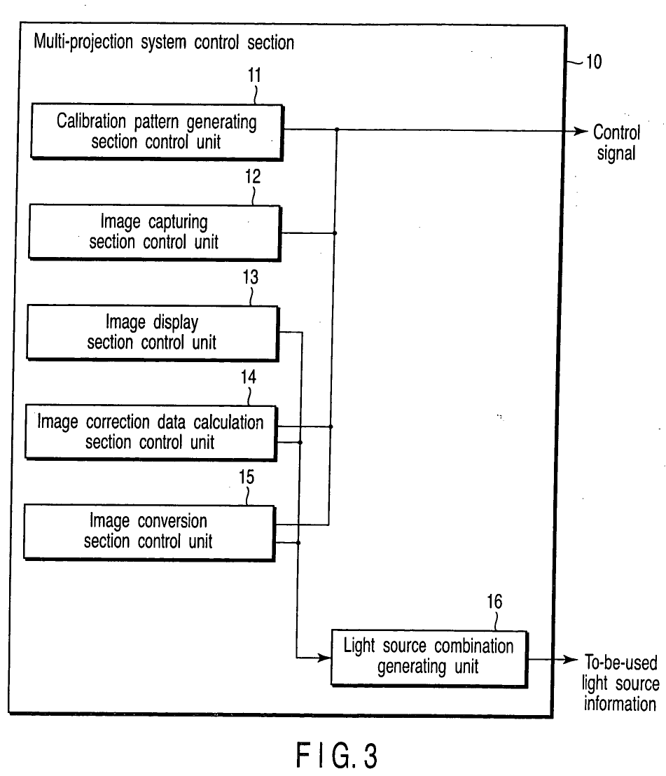

FIG. 3 is a block diagram that shows an example of the structure of the multi-projection system control section 10 shown in FIG. 1. As is shown in FIG. 3, the multi-projection system control section 10 comprises a calibration pattern generating section control unit 11, an image capturing section control unit 12, an image display section control unit 13, an image correction data calculation section control unit 14, an image conversion section control unit 15, and a light source combination generating unit 16.

Control signals from the control units 11 to 15 are delivered to the image display section 20, calibration pattern generating section 30, image capturing section 40, image correction data calculation section 50 and image conversion section 60. The control signals control these respective sections. Combination information on light sources for illumination is set in the multi-projection system control section 10. On the basis of information from the image display section control unit 13, image correction data calculation section control unit 14 and image conversion section control unit 15, the light source combination generating unit 16 selects light source combination information, which is to be actually used, from preset light source combination information. The selected combination information is output as to-be-used light source information.

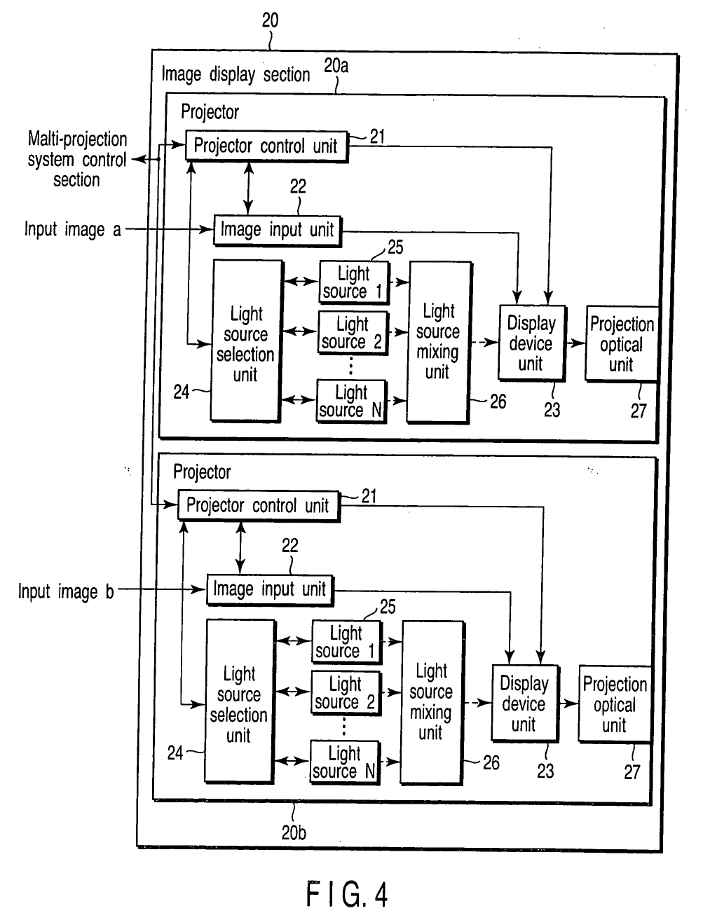

FIG. 4 is a block diagram that shows an example of the structure of the image display section 20 shown in FIG. 1. As mentioned above, in the present embodiment, the image display section 20 includes the projector 20a (projection unit) and projector 20b (projection unit). Each of the projectors 20a and 20b comprises a projector control unit 21, an image input unit 22, a display device unit 23, a light source selection unit 24, a plurality of light sources 25, a light source mixing unit 26 and a projection optical unit (projection optical system) 27.

The projector control unit 21 receives control signals (e.g. to-be-used light source information) from the multi-projection system control section 10. The projector control unit 21 controls the respective units in the projector. The image input unit 22 receives image data of an input image (input image a, input image b). Based on the image data from the image input unit 22, the display device unit 23 executes image display. The display device unit 23 is composed of a display device such as an LCD or a DMD.

The light source selection unit 24 selects a to-be-used light source on the basis of to-be-used light source information (light source combination information) from the projector control unit 21. Specifically, one of an N-number of light sources 25, which is designated by the to-be-used light source information, is selected. A lamp, such as a super-high pressure mercury lamp or a xenon lamp, or an LED is usable as the light source 25. Only the light source 25, which is selected from the N-number of light sources 25, is caused to emit light, and the emission light from the light source 25 is mixed by the light source mixing unit 26. The mixed light from the light source mixing unit 26 illuminates the display device unit 23, and the image on the display device unit 23 is projected onto the screen via the projection optical unit 27.

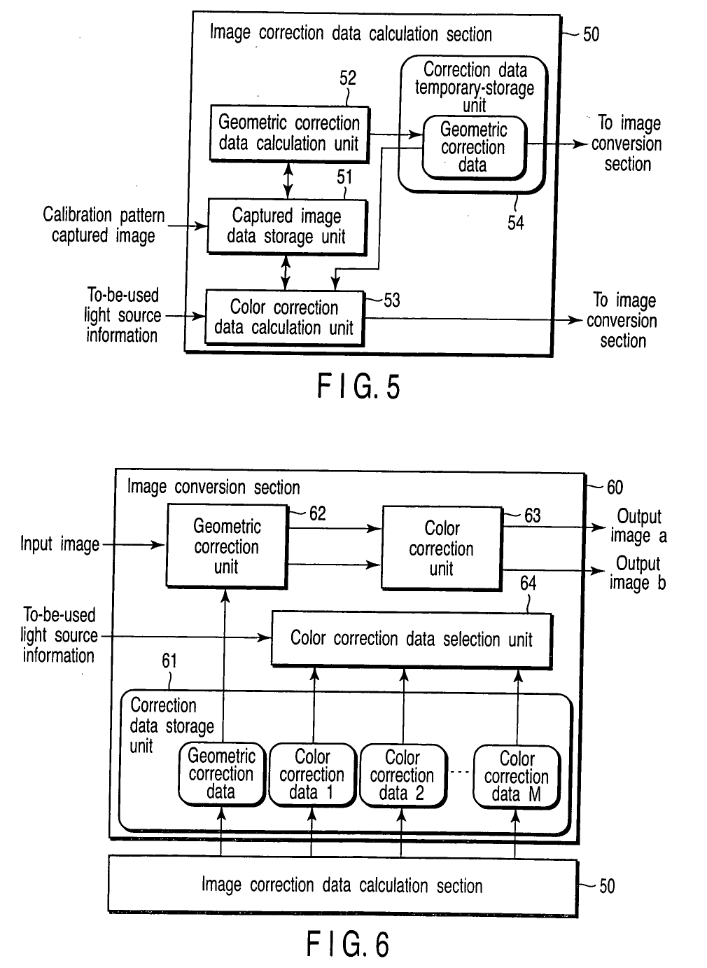

FIG. 5 is a block diagram that shows an example of the structure of the image correction data calculation section 50 shown in FIG. 1. As is shown in FIG. 5, the image correction data calculation section 50 comprises a captured image data storage unit 51, a geometric correction data calculation unit 52, a color correction data calculation unit 53 and a correction data temporary-storage unit 54.

The captured image data storage unit 51 stores image information of the calibration pattern captured image, which is captured by the image capturing section 40 (e.g. digital camera). Based on the image information of the calibration pattern captured image, the geometric correction data calculation unit 52 and color correction data calculation unit 53 calculate geometric correction data and color correction data. The calculated geometric correction data and color correction data are delivered to the image conversion section 60 as calibration data. Specifically, the geometric correction data that is calculated by the geometric correction data calculation unit 52 is stored in the correction data temporary-storage unit 54. Using the geometric correction data that is stored in the correction data temporary-storage unit 54 and the to-be-used light source information that is delivered from the multi-projection system control section 10, the color correction data calculation unit 53 calculates color correction data. In other words, the color correction data calculation unit 53 calculates color correction data corresponding to each of light source combinations with respect to each light source combination.

The geometric correction data is used in order to correct projection positions of the images projected by the respective projectors. The color correction data is used to correct luminance, chrominance, color non-uniformity, gamma (γ), etc. of the image projected by each projector. For example, the color correction data includes matrix data for correcting differences in chrominance and luminance of the image projected by each projector, gain correction data for correcting color non-uniformity of the image projected by each projector, smoothing data for correcting differences in luminance of overlapping parts of images projected by the projectors, offset correction data for correcting the black level (offset level) of the image projected by each projector, and gamma correction data for correcting differences in gamma characteristics of the projectors.

FIG. 6 is a block diagram that shows an example of the structure of the image conversion section 60 shown in FIG. 1. As is shown in FIG. 6, the image conversion section 60 comprises a correction data storage unit 61, a geometric correction unit 62, a color correction unit 63 and a color correction data selection unit 64.

The correction data storage unit 61 receives the geometric correction data that is calculated by the image correction data calculation unit 50 and the color correction data that corresponds to the light source combination. Using the geometric correction data stored in the correction data storage unit 61, the geometric correction unit 62 executes a geometric correction process for the image data of the input image. The color correction data selection unit 64 selects, from the correction data storage unit 61, the color correction data that corresponds to the to-be-used light source information from the multi-projection system control section 10. Specifically, the color correction data selection unit 64 selects the color correction data that corresponds to the designated light source combination. The color correction unit 63 executes a color correction process, using the correction image information for each projector from the geometric correction data and the color correction data selected by the color correction data selection unit 64. The output image data a and output image data b, which have been subjected to the correction process, are delivered to the projector 20a and projector 20b of the image display section 20.

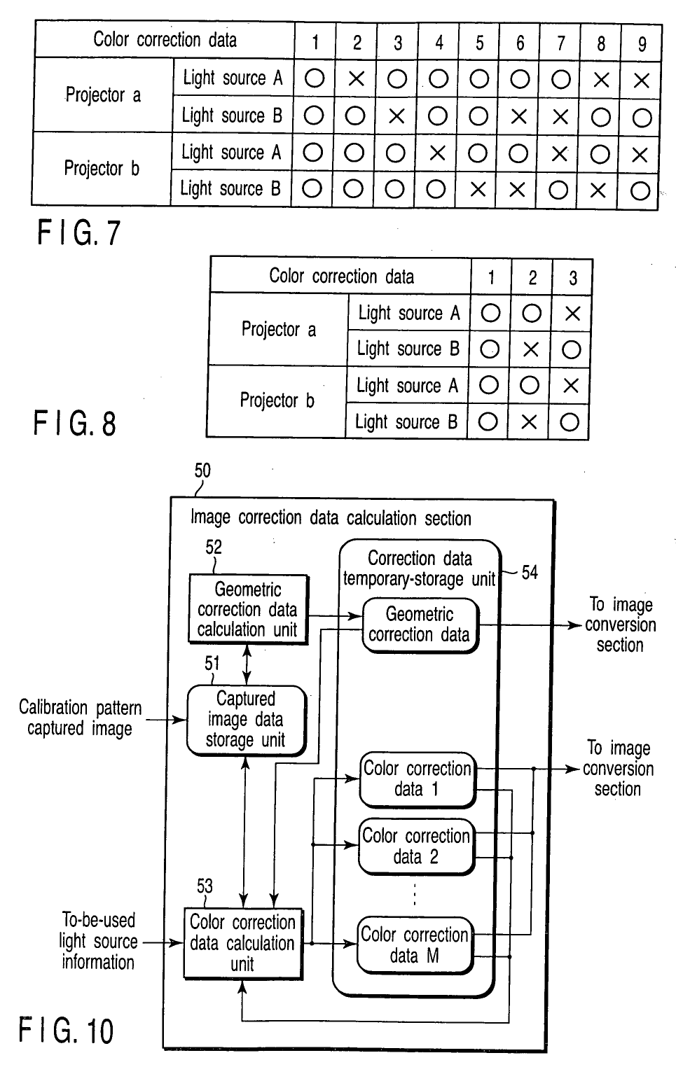

FIG. 7 is a view for explaining examples of the light source combinations. Assume now that the number P of projectors is 2, and the number N of light sources in each projector is 2. In FIG. 7, the light source, which is turned on, is indicated by a circle mark (◯). In this example, all combinations of light sources, in which at least one light source in each projectors is turned on, are set. Nine (M=9) color correction data are set. When color correction data is acquired, calibration pattern captured images are successively acquired with respect to all the nine light source combinations. Color correction data is calculated as calibration data from the image data of the acquired calibration pattern captured images. In this example, since the number of light source combinations is large, a long time is needed to acquire the calibration data. However, if at least one light source in each projector is operable, proper image display can continuously be executed.

FIG. 8 shows other examples of the light source combinations. In these examples, too, the number P of projectors is 2, and the number N of light sources in each projector is 2. In the examples, the combinations are set such that the number of light sources that are turned on is equal between the respective projectors. Thereby, the emission amount (luminance) of the light source can be made substantially equal between the projectors. In the examples, at first, all the light sources are turned on. If a light source in any one of the projectors has become defective (e.g. lamp burn-out), a light source in the other projector, which has most similar light emission characteristics to the defective light source, is turned off. Thus, in the examples, three (M=3) color correction data are set. When color correction data is acquired, calibration pattern captured images are successively acquired with respect to all the three light source combinations, like the case illustrated in FIG. 7. Color correction data is calculated as calibration data from the image data of the acquired calibration pattern captured images. When the color correction data is to be acquired, a method that is described below may be adopted.

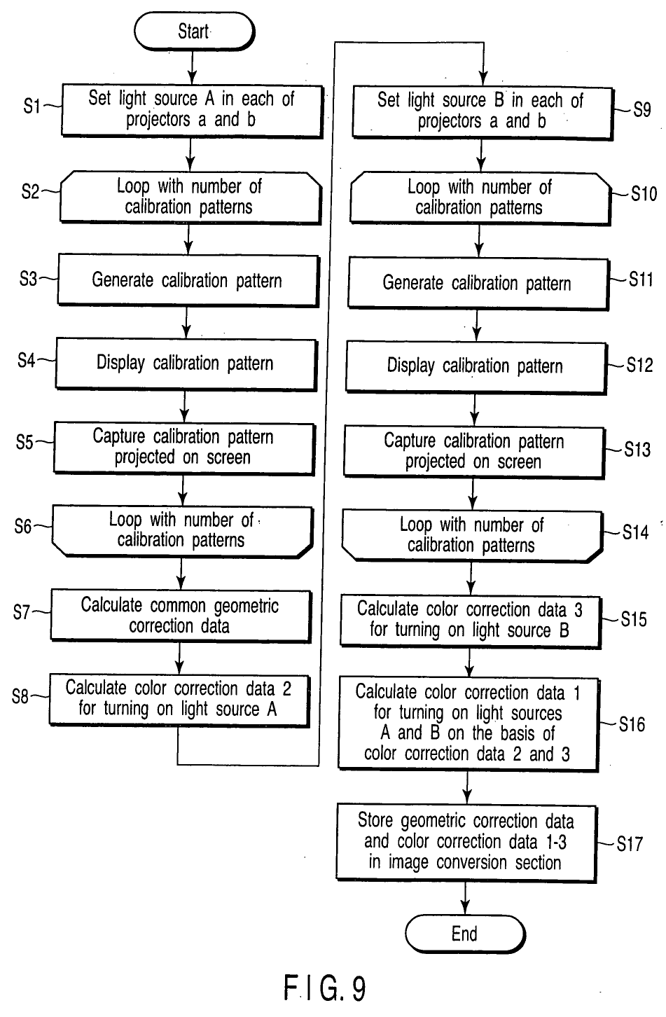

FIG. 9 is a flow chart illustrating a method of calculating the calibration data. FIG. 10 is a block diagram that shows the structure of the image correction data calculation section 50 in the case of using the calibration data calculation method illustrated in FIG. 9.

To start with, in each of the projector a (corresponding to projector 20a) and the projector b (corresponding to projector 20b), the light source 25 of the image display section 20 is set to the light source A (S1).

Then, in accordance with the number of images of calibration patterns, the following steps are executed (S2). To begin with, the calibration pattern generating section 30 generates a calibration pattern (S3). The generated calibration pattern is displayed on the display device unit 23 of the image display section 20 (S4). The calibration pattern that is displayed on the display device unit 23 is projected on the screen, and the projected calibration pattern is captured by the image capturing section 40 (S5). The steps S3 to S5 are repeated by the number of images of calibration patterns (S6). Using the calibration pattern captured image, the image correction data calculation section 50 calculates geometric correction data that is common to all the light source combinations (S7). Further, the image correction data calculation section 50 calculates color correction data (corresponding to color correction data 2 in FIG. 8) in the case where the light source A is turned on in each of the projector a and projector b (S8).

Subsequently, in each of the projector a and the projector b, the light source 25 of the image display section 20 is set to the light source B (S9).

Then, in accordance with the number of images of calibration patterns, the following steps are executed (S10). To begin with, the calibration pattern generating section 30 generates a calibration pattern (S11). The generated calibration pattern is displayed on the display device unit 23 of the image display section 20 (S12). The calibration pattern that is displayed on the display device unit 23 is projected on the screen, and the projected calibration pattern is captured by the image capturing section 40 (S13). The steps S11 to S13 are repeated by the number of images of calibration patterns (S14). The image correction data calculation section 50 calculates color correction data (corresponding to color correction data 3 in FIG. 8) in the case where the light source B is turned on in each of the projector a and projector b (S15).

Next, using the color correction data 2 and color correction data 3 that are calculated in steps S8 and S15, color correction data (corresponding to color correction data 1 in FIG. 8) in the case where the light source A and light source B are turned on in each of the projector a and projector b is calculated (S16). Then, the geometric correction data and color correction data 1-3, which are calculated in the above steps, are stored in the image conversion section 60 as calibration data (S17).

According to the above-described method, there is no need to capture calibration patterns in association with all the light source combinations. Therefore, the time for acquiring calibration data can be reduced.

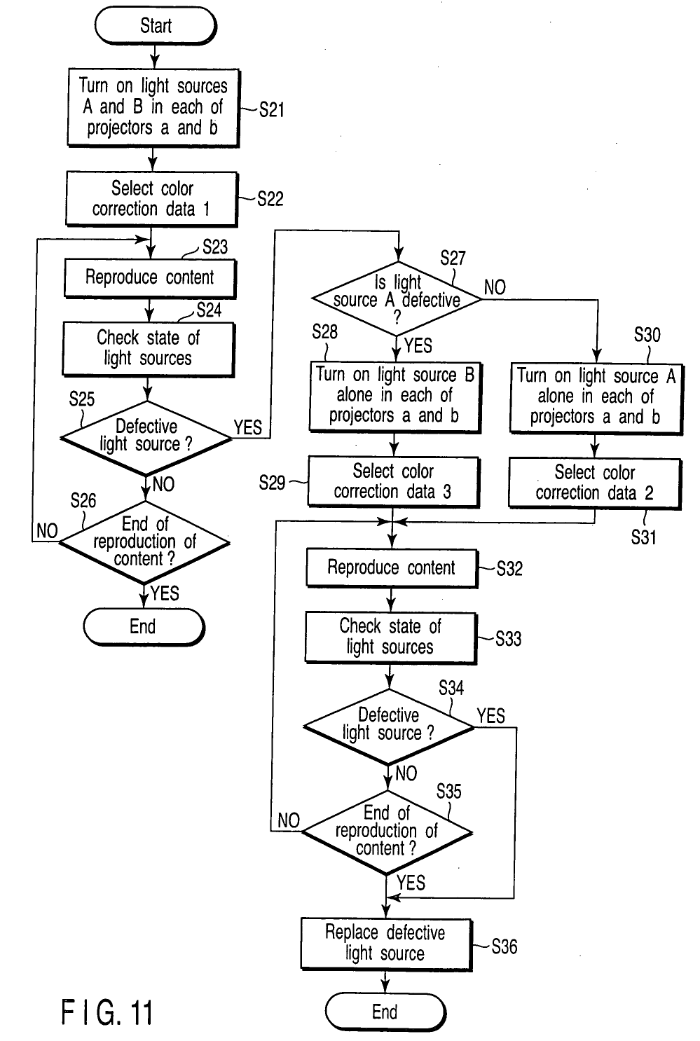

FIG. 11 is a flow chart that illustrates an operation at a time of displaying an image (content) in the multi-projection system of the present embodiment.

To start with, the light source A and light source B in each of the projector a and projector b are turned on (S21), and the color correction data 1 in the image conversion section 60 is selected (S22). Subsequently, the image display section 20 reproduces content, and the states of the light sources are constantly checked from the start of reproduction of content to the end of reproduction of content (S23 to S26).

If the light source is determined to be defective (lamp burn-out) in step S25, it is determined which of the light source A and light source B is defective (S27). If the light source A is defective, the turn-on state of the light sources is switched such that only the light source B is turned on in each of the projector a and projector b (S28), and the color correction data 3 in the image conversion section 60 is selected (S29). If the light source B is defective, the turn-on state of the light sources is switched such that only the light source A is turned on in each of the projector a and projector b (S30), and the color correction data 2 in the image conversion section 60 is selected (S31). When such a defective light source occurs, the color correction data that is calculated in advance is used, and thus the content can continuously be displayed with substantially no interruption of reproduction of content.

Subsequently, the states of the light sources are constantly checked until the end of reproduction of content (S32 to S35). After the end of reproduction of content, the system is shut down, and the defective light source is replaced (S36).

As has been described above, according to the present embodiment, the calibration data is calculated in advance with respect to each of combinations of light sources that are to be turned on. Thus, there is no need to newly calculate calibration data when a defective light source occurs. Therefore, the content can continuously be displayed with substantially no interruption of reproduction of display of content. Even in the case where a defective light source occurs, proper display can be maintained.

### Embodiment 2

Next, a multi-projection system (image projection system) according to a second embodiment of the invention is described. The basic structure of the second embodiment is the same as that of the first embodiment. In the description below, different points from the first embodiment are mainly described.

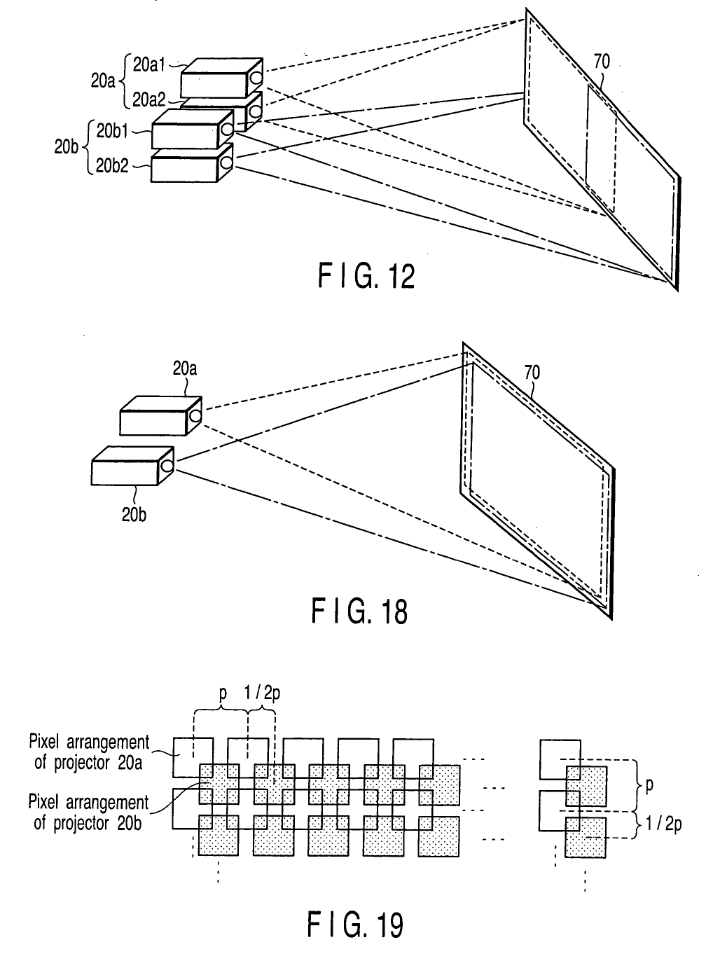

FIG. 12 is a view illustrating the external appearance of the multi-projection system (image projection system) according to the second embodiment.

In the first embodiment, one projection unit is composed of one projector. In the second embodiment, one projection unit is composed of a plurality of projectors. Specifically, as shown in FIG. 12, a projection unit 20a is composed of two stacked projectors 20a1 and 20a2, and a projection unit 20b is composed of two stacked projectors 20b1 and 20b2. In the first embodiment, one projector includes a plurality of light sources. In the second embodiment, one projector includes one light source. Thus, as regards the projection unit, like the first embodiment, one projection unit includes a plurality of light sources.

The projectors 20a1 and 20a2 receive the same image data, and the projectors 20a1 and 20a2 project substantially the same image at the same position on the same screen 70. The same applies to the projectors 20b1 and 20b2. By projecting substantially the same image at the same position on the screen from the plural projectors in this manner, the luminance of the image can be enhanced. Besides, one projection unit includes two projectors. Hence, even if the light source of one of the projectors becomes defective, content can continuously be displayed if the other projector normally operates.

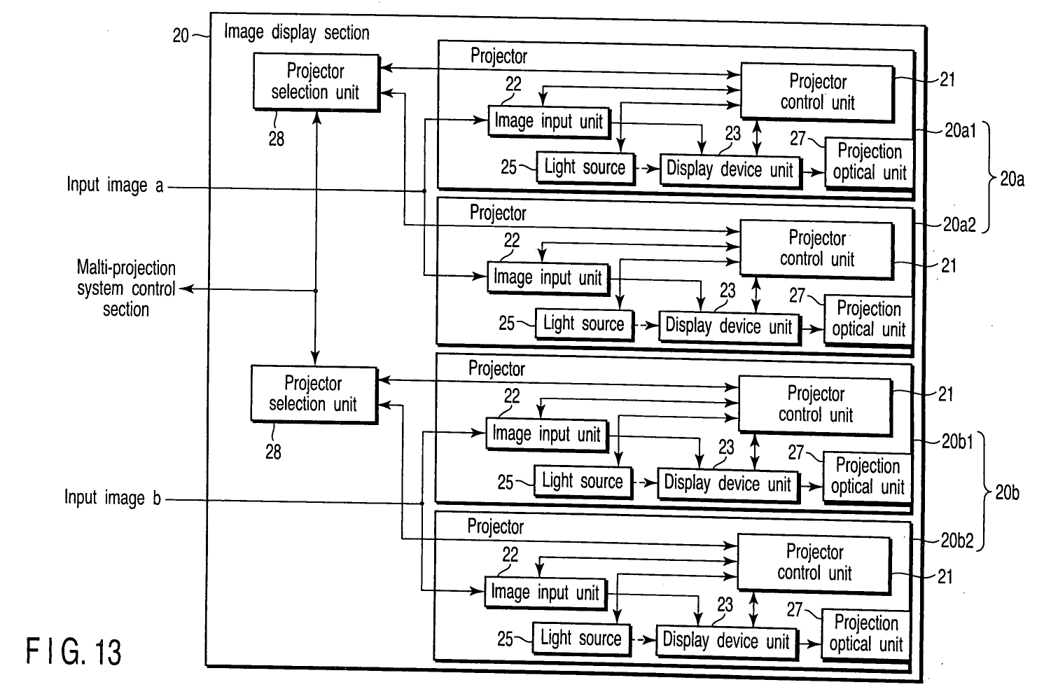

FIG. 13 is a block diagram that shows an example of the structure of the image display section 20 in the present embodiment. The image display section 20 includes the projection units 20a and 20b. The projection unit 20a includes the projectors 20a1 and 20a2, and the projection unit 20b includes the projectors 20b1 and 20b2. Each of the projection units 20a and 20b is provided with a projector selection unit 28. Each of the projectors 20a1, 20a2, 20b1 and 20b2 has the same basic structure as in the first embodiment (see FIG. 4). In the second embodiment, however, the number of light sources 25 in each projector is one, and thus the light source mixing unit 26 shown in FIG. 4 is not provided.

The projector control unit 21 receives control signals (to-be-used light source information, etc.) from the multi-projection system control section 10 via the projector selection unit 28. The projector control unit 21 controls the respective units in the projector. The image input unit 22 receives image data of an input image (input image a, input image b). Based on the image data from the image input unit 22, the display device unit 23 executes image display. The projector control unit 21 determines whether the light source 25 is to be turned on or not, on the basis of to-be-used light source information (light source combination information). Emission light from the turned-on light source 25 illuminates the display device unit 23, and the image on the display device unit 23 is projected onto the screen via the projection optical unit 27.

In the present embodiment, like the first embodiment, the calibration data is calculated in advance with respect to each of combinations of light sources that are to be turned on. Thus, there is no need to calculate calibration data when a defective light source occurs. Therefore, like the first embodiment, even if a defective light source occurs, proper display can be maintained.

### Embodiment 3

Next, a multi-projection system (image projection system) according to a third embodiment of the invention is described. The basic structure of the third embodiment is the same as that of the first embodiment. In the description below, different points from the first embodiment are mainly described.

In the first embodiment, for example, the combination of light sources is changed when a defective light source occurs, and thus the number of light sources that are used decreases. Consequently, the luminance of the image that is projected from the projection unit decreases, and the viewer may possibly have unpleasant sensation. In this third embodiment, when the light source combination is changed, the emission amount of the light source is also changed. This can reduce a variation in luminance of the image, which is projected from the projection unit, before and after the change of the light source combination.

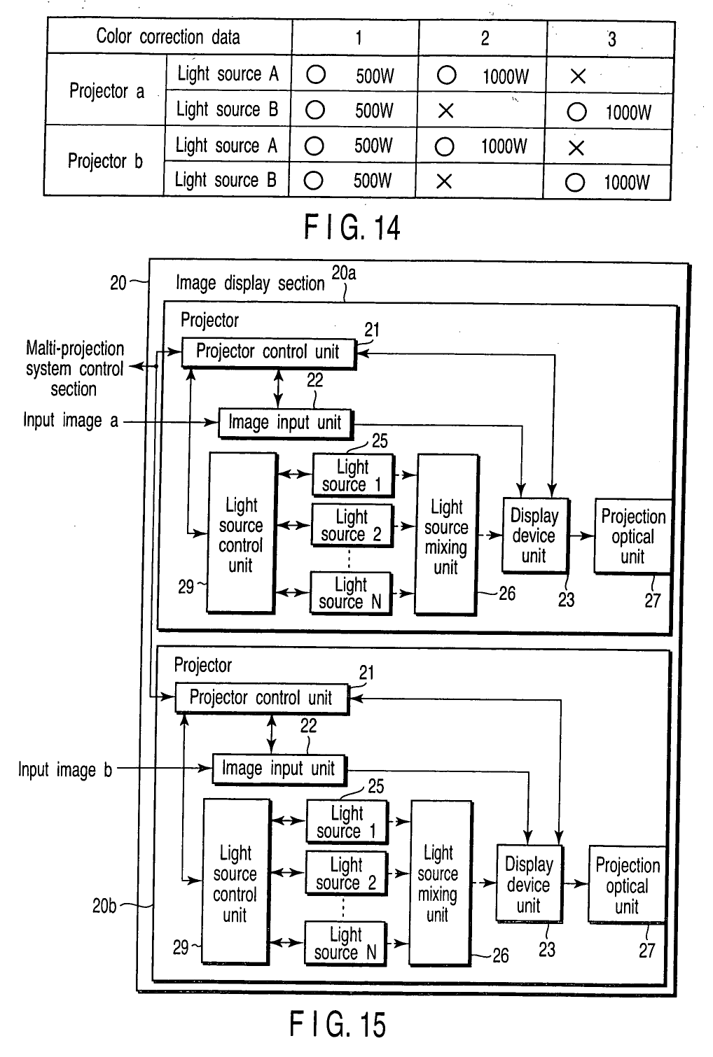

FIG. 14 is a view for explaining examples of combinations of light sources and light emission amounts of the light sources. As shown in FIG. 14, when both the light sources A and B are turned on in each of the projectors a and b, the output of each light source is 500 W. When the light source A alone is turned on in each of the projectors a and b, the output of each light source that is turned on is 1000 W. Similarly, when the light source B alone is turned on in each of the projectors a and b, the output of each light source that is turned on is 1000 W. In short, the number of light sources that are turned on in each projector (projection unit) is inversely proportional to the emission amount of each light source that is turned on in each projector (projection unit). As a result, the viewer can recognize the image, which is projected on the screen, with substantially equal luminance before and after the change of the light source combination.

FIG. 15 is a block diagram that shows an example of the structure of the image display section 20 in the third embodiment. Like the first embodiment, the image display section 20 includes the projector 20a (projection unit) and projector 20b (projection unit). Each of the projectors 20a and 20b comprises a projector control unit 21, an image input unit 22, a display device unit 23, a light source control unit 29, a plurality of light sources 25, a light source mixing unit 26 and a projection optical unit (projection optical system) 27.

The projector control unit 21 receives control signals (e.g. to-be-used light source information) from the multi-projection system control section 10. The projector control unit 21 controls the respective units in the projector. The image input unit 22 receives image data of an input image (input image a, input image b). Based on the image data from the image input unit 22, the display device unit 23 executes image display.

The light source control unit 29 selects to-be-used light sources and sets the emission amount (watt) of the to-be-used light sources, on the basis of to-be-used light source information (light source combination information) from the projector control unit 21. The selected light source 25 emits light with the set emission amount, and the emission light from the light source 25 is mixed by the light source mixing unit 26. The mixed light from the light source mixing unit 26 illuminates the display device unit 23, and the image on the display device unit 23 is projected onto the screen via the projection optical unit 27.

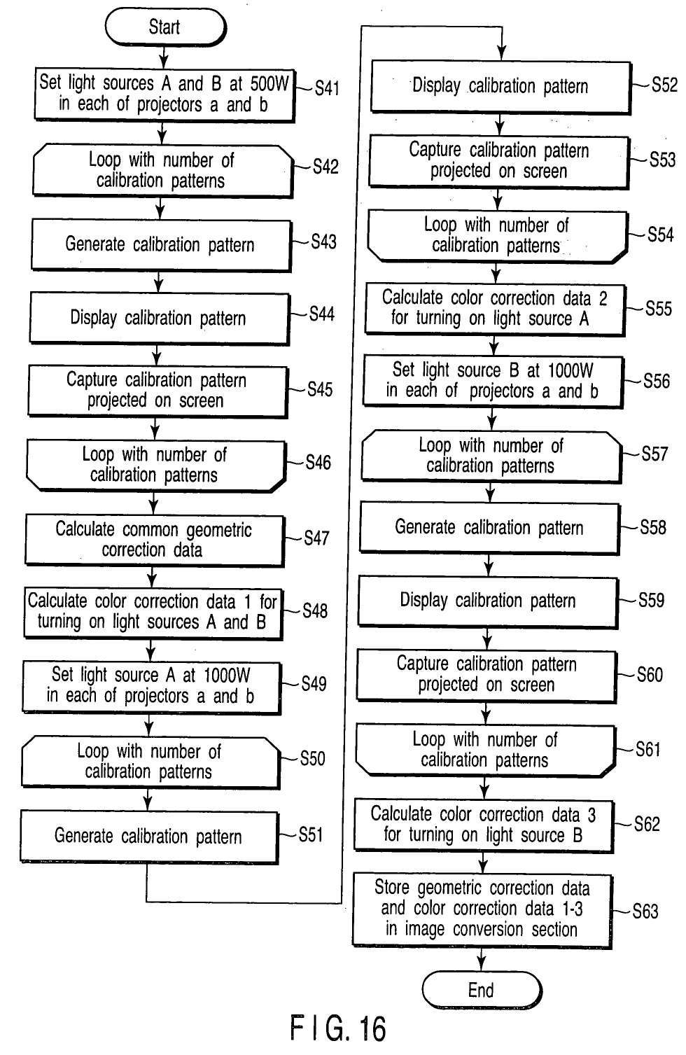

FIG. 16 is a flow chart illustrating a method of calculating calibration data in the present embodiment.

To start with, in each of the projector a and the projector b, the light sources 25 of the image display section 20 are set to the light source A and light source B, and the output of each of the light sources A and B is set at 500 W (S41).

Then, in accordance with the number of images of calibration patterns, the following steps are executed (S42). To begin with, the calibration pattern generating section 30 generates a calibration pattern (S43). The generated calibration pattern is displayed on the display device unit 23 of the image display section 20 (S44). The calibration pattern that is displayed on the display device unit 23 is projected on the screen, and the projected calibration pattern is captured by the image capturing section 40 (S45). The steps S43 to S45 are repeated by the number of images of calibration patterns (S46). Using the calibration pattern captured image, the image correction data calculation section 50 calculates geometric correction data that is common to all the light source combinations (S47). Further, the image correction data calculation section 50 calculates color correction data (corresponding to color correction data 1 in FIG. 14) in the case where the light source A and light source B are turned on at 500 W in each of the projector a and projector b (S48).

Subsequently, in each of the projector a and the projector b, the light source 25 of the image display section 20 is set to the light source A and the output of the light source A is set at 1000 W (S49).

Then, in accordance with the number of images of calibration patterns, the following steps are executed (S50). To begin with, the calibration pattern generating section 30 generates a calibration pattern (S51). The generated calibration pattern is displayed on the display device unit 23 of the image display section 20 (S52). The calibration pattern that is displayed on the display device unit 23 is projected on the screen, and the projected calibration pattern is captured by the image capturing section 40 (S53). The steps S51 to S53 are repeated by the number of images of calibration patterns (S54). The image correction data calculation section 50 calculates color correction data (corresponding to color correction data 2 in FIG. 14) in the case where the light source A is turned on at 1000 W in each of the projector a and projector b (S55).

Subsequently, in each of the projector a and the projector b, the light source 25 of the image display section 20 is set to the light source B and the output of the light source B is set at 1000 W (S56).

Then, in accordance with the number of images of calibration patterns, the following steps are executed (S57). To begin with, the calibration pattern generating section 30 generates a calibration pattern (S58). The generated calibration pattern is displayed on the display device unit 23 of the image display section 20 (S59). The calibration pattern that is displayed on the display device unit 23 is projected on the screen, and the projected calibration pattern is captured by the image capturing section 40 (S60). The steps S58 to S60 are repeated by the number of images of calibration patterns (S61). The image correction data calculation section 50 calculates color correction data (corresponding to color correction data 3 in FIG. 14) in the case where the light source B is turned on at 1000 W in each of the projector a and projector b (S62).

Then, the geometric correction data and color correction data 1-3, which are calculated in the above steps, are stored in the image conversion section 60 as calibration data. In addition, the emission amounts (watt) of the turned-on light sources, which are associated with the color correction data 1-3, are also stored in the image conversion section 60 as calibration data (S63).

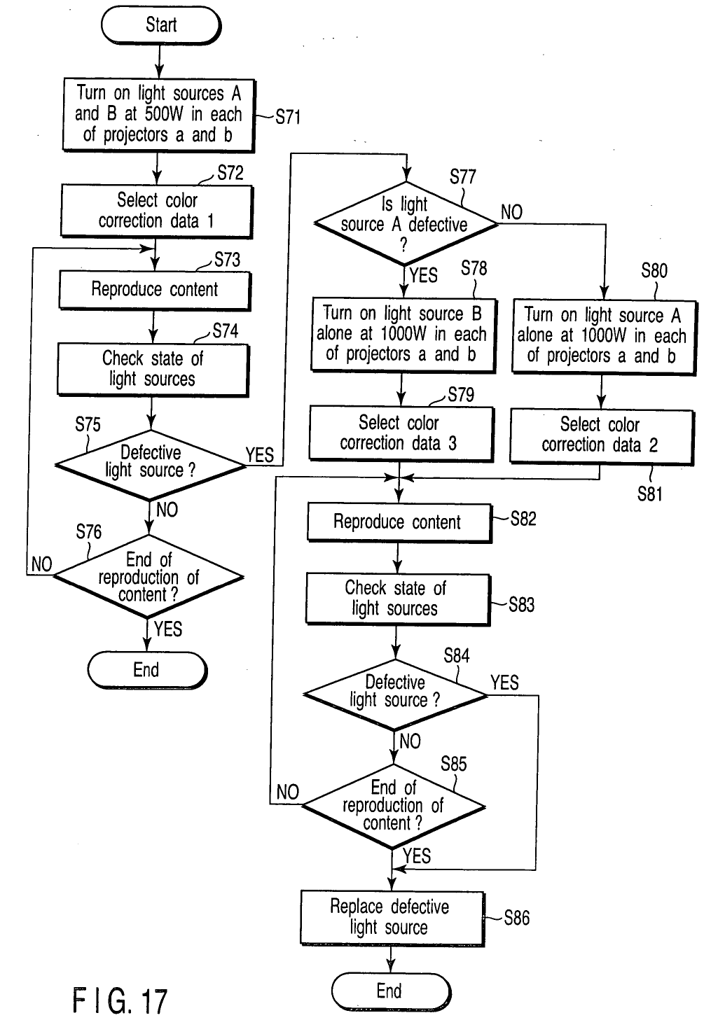

FIG. 17 is a flow chart that illustrates an operation at a time of displaying an image (content) in the multi-projection system of the present embodiment.

To start with, the light source A and light source B in each of the projector a and projector b are turned on at 500 W (S71), and the color correction data 1 in the image conversion section 60 is selected (S72). Subsequently, the image display section 20 reproduces content, and the states of the light sources are constantly checked from the start of reproduction of content to the end of reproduction of content (S73 to S76).

If the light source is determined to be defective (lamp burn-out) in step S75, it is determined which of the light source A and light source B is defective (S77). If the light source A is defective, the turn-on state of the light sources is switched such that only the light source B is turned on in each of the projector a and projector b and the output of the light source B is set at 1000 W (S78), and the color correction data 3 in the image conversion section 60 is selected (S79). If the light source B is defective, the turn-on state of the light sources is switched such that only the light source A is turned on in each of the projector a and projector b and the output of the light source A is set at 1000 W (S80), and the color correction data 2 in the image conversion section 60 is selected (S81). When such a defective light source occurs, the color correction data that is calculated in advance is used, and thus the content can continuously be displayed with substantially no interruption of reproduction of content.

Subsequently, the states of the light sources are constantly checked until the end of reproduction of content (S82 to S85). After the end of reproduction of content, the system is shut down, and the defective light source is replaced (S86).

As has been described above, according to the present embodiment, like the first embodiment, the calibration data is calculated in advance with respect to each of combinations of light sources that are to be turned on. Thus, there is no need to calculate calibration data when a defective light source occurs. Therefore, like the first embodiment, even in the case where a defective light source occurs, proper display can be maintained. Moreover, in the present embodiment, when the light source combination is changed, the emission amount of the light source is also changed. This can reduce a variation in luminance of the image, which is projected from the projection unit, and can maintain proper display without causing unpleasant sensation to the viewer.

### Embodiment 4

Next, a multi-projection system (image projection system) according to a fourth embodiment of the invention is described. The basic structure of the fourth embodiment is the same as that of the first embodiment. In the description below, different points from the first embodiment are mainly described.

FIG. 18 is a view illustrating the external appearance of the multi-projection system (image projection system) according to this fourth embodiment. FIG. 19 shows the state of pixel arrangements of images that are projected on the screen 70 by projectors 20a and 20b shown in FIG. 18.

In this embodiment, like the first embodiment, one projection unit is composed of one projector. In the present embodiment, as shown in FIG. 19, an image, which is projected on the screen 70 from the projector 20a, is shifted by half of a pitch pixel from an image, which is projected on the screen 70 from the projector 20b. In FIG. 19, the pixel pitch is p, and the shift amount is p/2. With this shift of the image, a high-definition image can be displayed.

In the present embodiment, like the first embodiment, the calibration data is calculated in advance with respect to each of combinations of light sources that are to be turned on. Thus, there is no need to calculate calibration data when a defective light source occurs. Therefore, like the first embodiment, even if a defective light source occurs, proper display can be maintained.

### Embodiment 5

Next, a multi-projection system (image projection system) according to a fifth embodiment of the invention is described. The basic structure of the fifth embodiment is the same as that of the first embodiment. In the description below, different points from the first embodiment are mainly described.

In this fifth embodiment, an LED unit, which is to be described below, is used for each light source 25. One LED unit includes a plurality of LEDs. One LED unit corresponds to one light source.

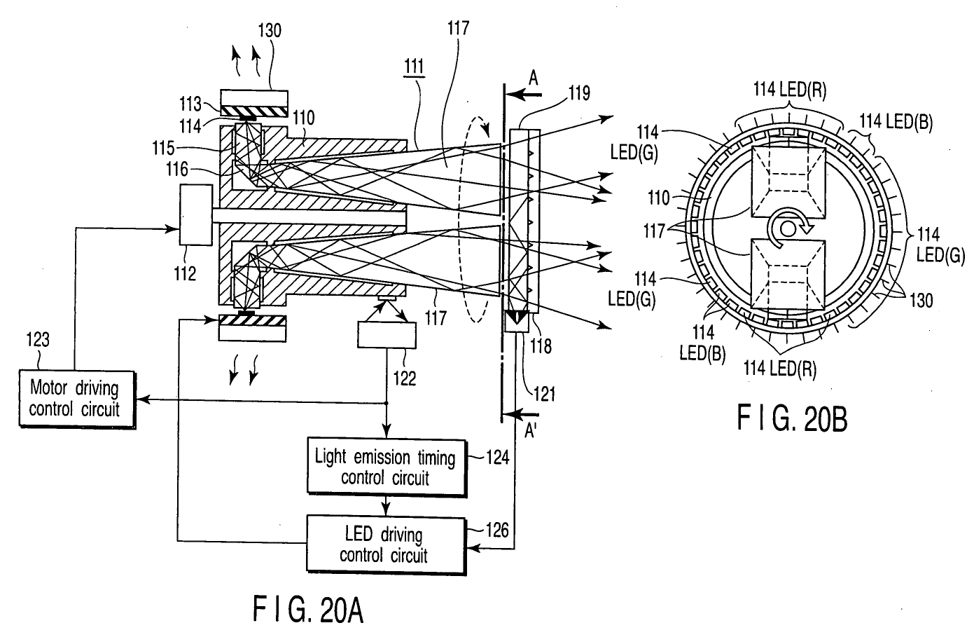

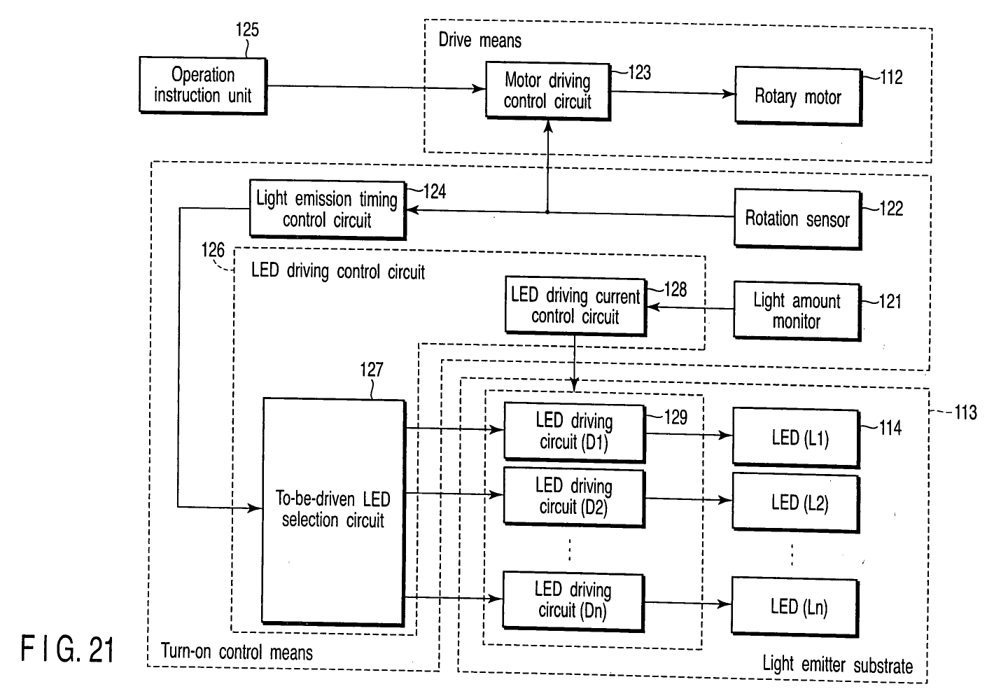

FIG. 20A and FIG. 20B show the structure of the light source 25 (LED unit) according to the fifth embodiment. FIG. 21 is a block diagram that shows the electrical configuration of the LED unit. FIG. 20B is a front view, as viewed in the direction of arrows A and A′ in FIG. 20A.

In the illumination unit (LED unit) of this embodiment, rectangular light guide rod members (optical means) 111, which are attached to a rotatable rod holder (holding member) 110 and have L-shaped optical faces, are rotated by a rotary motor (driving means) 112. A plurality of LEDs (light emitters) 114 are arranged on the inner periphery of a drum-shaped light emitter substrate 113. The LEDs are successively turned on in accordance with the rotation of the light guide rod members 111.

The light guide rod member 111 is formed to have a rectangular shape because a high efficiency is realized by the similarity in shape between the light guide rod member 111 and the LED, and a loss is minimized when the light guide rod member 111 is bent in the L-shape. The light guide rod member 111 is formed of glass or resin that is transparent to a wavelength range of illumination light flux. Moreover, from the standpoint of efficiency, the light guide rod member 111 is provided with mirror-finished optical faces so as to realize light guide by total reflection at its side surfaces.

The L-shaped light guide rod member 111 may be formed as one piece, or may be formed by coupling three components, that is, a prismatic parallel rod 115, a reflection prism 116 that is provided with a reflective coating on its oblique surface for deflecting the light path, and a taper rod 117. In the case where the light guide rod member 111 is formed by coupling the three components, it is not necessary that the parallel rod 115, reflection prism 116 and taper rod 117 have the same refractive index. It is preferable that the refractive index of the reflection prism 116 be higher than that of each of the parallel rod 115 and taper rod 117, since the amount of leak light from the side surface is decreased. To increase the refractive index of the reflection prism 116 can realize the following advantage. That is, light rays that pass through the reflection prism 116 include light rays that travel at such an angle as to pass through, without reflection by the side surfaces of the parallel rod 115 or taper rod 117. Such light rays can be reflected to the inside of the reflection prism 116 at the connection face between the parallel rod 115 and reflection prism 116, or at the connection face between the taper rod 117 and reflection prism 116. As a result, the amount of leak light from the side surfaces can be reduced.

Two sets of red (R) LEDs 114, two sets of green (G) LEDs 114 and two sets of blue (B) LEDs 114 are arranged on the inner periphery of the drum-shaped light emitter substrate 113.

The emission end surfaces of the light guide rod members 111 function as virtual light sources, and a to-be-illuminated region (not shown) is illuminated. In the present embodiment, a light beam shaping diffuser (LSD (trademark in the U.S.)) 118, which is a light beam shape converting element, is disposed behind the emission end surfaces of the light guide rod members 111 in order to reduce angular non-uniformity.

A rotation sensor 122 for detecting the rotational position of the rod holder 110 is provided near the side surface of the rod holder 110. A photo-reflector, for instance, is usable as the rotation sensor 122. Light, which is reflected by a reflection plate attached to the side surface of the rod holder 110, is detected, and thus a single turn of the rod holder 110 can be detected.

A rotational position detection signal that is obtained by the rotation sensor 122 is input to a motor driving control circuit 123 and a light emission timing control circuit 124.

The motor driving control circuit 123 controls the rotary motor 112. The motor driving control circuit 123 and the rotary motor 112 constitute drive means for driving and rotating the light guide rod members 111. If an operation start signal is input from an operation instruction section 125 to the motor driving control circuit 123 by a button operation by the user, the motor driving control circuit 123 starts rotation of the rotary motor 112 and executes such a driving control as to rotate the rotary motor 112 at a fixed speed in accordance with a rotational position detection result of the rod holder 110 by the rotary sensor 122.

The light emission timing control circuit 124, together with a light amount monitor 121, rotation sensor 122 and an LED driving control circuit 126 that receives a light amount detection result from the light amount monitor 121, constitutes turn-on control means for controlling the light emission timing of the LEDs 114. The LED driving control circuit 126 comprises a to-be-driven LED selection circuit 127 and an LED driving current control circuit 128.

Based on the rotational position detection of the rod holder 110 by the rotation sensor 122, the light emission timing control circuit 124 generates a timing signal and delivers the generated timing signal to the to-be-driven LED selection circuit 127 of the LED driving control circuit 126. In accordance with the input timing signal, the to-be-driven LED selection circuit 127 selectively supplies driving control signals to LED driving circuits 129 for driving the LEDs 114 mounted on the light emitter substrate 113. Thereby, the LEDs 114, which are located at the positions of the incidence surfaces of the light guide rod members 111, that is, the incidence surfaces of the parallel rods 115, are successively turned on. At this time, the LED driving current control circuit 128 of the LED driving control circuit 126 controls the driving currents that are produced by the LED driving circuits 129 for driving the LEDs 114, so as to optimize the light emission amounts of the LEDs 114 in accordance with the increase/decrease in emission light, which is detected by the light amount monitor 121.

A radiator plate 130 is provided on the outer periphery of the drum-shaped light emitter substrate 113. The radiator plate 130 radiates heat that is produced by the light emission by the LEDs 114, thus preventing the characteristics of the LEDs 114 from varying due to heat. Hence, even if the illumination unit is continuously operated, stable illumination is achieved.

As has been described above, the plural LEDs 114 are successively caused to emit light in a pulsating manner, and the relationship in relative position between the LEDs 114 and the light guide rod members 111 is varied in accordance with the switching of light emission of the LEDs 114. Thus, the colors of emission light are switched in the order of red (R), blue (B), green (G), red (R), blue (B) and green (G) while the light guide rod member 111 makes a single turn, and high-luminance 3-color LEDs are effectively realized. As a result, 3-color light with a large emission amount and enhanced parallelism can be obtained from the emission end surfaces of the light guide rod members 111. The order of colors of emission light is not limited to the above-mentioned one, and the order may optionally be changed.

In the above-described structure, the change in relative position between the LEDs 114 and the light guide rod members 111 is realized by rotating the light guide rod members 111. Alternatively, the relative position may be changed by moving the LEDs 114. From the standpoint of power supply to the LEDs 114, however, it is preferable to move the light guide rod members 111. For example, non-uniformity in light intensity distribution within the emission end surface of the light guide rod member 111 is small if the light guide rod member 111 has a certain length. It is thus possible to regard the emission end surface as a virtual rectangular planar light source with high uniformity. Therefore, it is possible to perform critical illumination with a conjugate relation being established between the to-be-illuminated region and the emission end surface of the light guide rod member 111. In the case of the structure of this embodiment in which a plurality of light guide rod members 111 are used, a peripheral edge portion of the emission end surface of each light guide rod member 111 is projected on the to-be-illuminated region, leading to non-uniformity in illumination. In fact, since the rotational operation is executed, the illuminated region becomes circular. If the speed of rotation is adjusted, the peripheral edge portion may not be visually recognized. However, at some time instant, the peripheral edge portion of the emission end surface of the rod may become visible as non-uniformity in illumination, and the non-uniformity in illumination shifts in the illuminated region with time. In a case where an image projection system is constructed by disposing a display device at a to-be-illuminated region, the scheme is not applicable to the display device that executes time-division gray-scale representation. On the other hand, in the case of Koehler illumination in which an angular intensity distribution of light flux from the light guide rod member 111 is converted to a positional intensity distribution on the illuminated region, the angular intensity distribution of light flux from the light guide rod member 111 is unchanged even when the light guide rod member 111 is moved. Thus, it is possible to realize an illumination unit with small non-uniformity in illumination on the illuminated region.

In the present embodiment, like the first embodiment, the calibration data is calculated in advance with respect to each of combinations of light sources (LED units) that are to be turned on. Thus, there is no need to calculate calibration data when a defective light source occurs. Therefore, like the first embodiment, even if a defective light source occurs, proper display can be maintained.

As has been described above, according to the present invention, the calibration data is calculated in advance with respect to each of combinations of light sources that are to be turned on. Thereby, even if a defective light source occurs, an image can continuously be displayed and proper display can be maintained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image projection system that projects a plurality of images on a screen to form a single image, comprising:
a plurality of projection units each including a plurality of light sources, a light source selection unit that selects at least one of the light sources and a display unit that is illuminated by said at least one light source selected by the light source selection unit, images that are displayed on the display units of the projection units being formed on the basis of different image data;
a combination selection unit that selects a combination of the light sources that are selected by the light source selection unit, from among a plurality of predetermined combinations of the light sources included in the projection units;
a storage unit that stores, in accordance with the plurality of predetermined combinations of the light sources, a plurality of calibration data that are used for adjusting illumination light amounts of the light sources and/or the images that are displayed by the display units; and
a control unit that adjusts the illumination light amounts of the light sources and/or the images that are displayed by the display units, using the calibration data that corresponds to the combination of the light sources selected by the combination selection unit.

2. The image projection system according to claim 1, wherein each of the projection units is composed of a single projector that includes the display unit and a plurality of the light sources, and a single image is projected on the screen from the single projector.

3. The image projection system according to claim 1, wherein each of the projection units is composed of a plurality of projectors each including one said light source, and
the plurality of projectors, which are included in each of the projection units, are configured such that images, which are based on common image data, are projected on the screen at substantially the same position on the screen.

4. The image projection system according to claim 1, wherein when two or more of the light sources can normally be turned on in each of the projection units, each of the light source selection units selects two or more light sources.

5. The image projection system according to claim 1, wherein in a case where one of the light sources, which are selected by the light source selection unit in a given one of the projection units, fails to normally operate, the control unit adjusts the image using the calibration data that corresponds to a combination of light sources, which is not selected by the combination selection unit.

6. The image projection system according to claim 5, wherein the light source selection unit in the projection unit, which is other than said given one of the projection units, does not select the light source that has light emission characteristics closest to light emission characteristics of the light source that fails to normally operate.

7. The image projection system according to claim 1, wherein said predetermined combinations of light sources include all combinations in which at least one of the light sources is turned on in each of the projection units.

8. The image projection system according to claim 1, wherein said predetermined combinations of light sources include only combinations in which the number of light sources, which are turned on, is equal between the projection units.

9. The image projection system according to claim 8, wherein the storage unit stores the calibration data such that the images that are projected on the screen by the projection units are recognized by a viewer as images with a substantially equal luminance.

10. The image projection system according to claim 9, wherein the storage unit stores the calibration data such that the number of light sources, which are turned on, is inversely proportional to the illumination light amount of each light source that is turned on.

11. The image projection system according to claim 1, wherein the light source is composed of a lamp light source, and the control unit adjusts at least the image that is displayed by the display unit.

12. The image projection system according to claim 1, wherein the light source is composed of an LED light source, and the control unit adjusts at least the illumination light amount of the LED light source.

13. The image projection system according to claim 1, wherein the plurality of projection units are arranged such that the images that are projected by the projection units are located adjacent to each other on the screen.

14. The image projection system according to claim 13, wherein the plurality of projection units are arranged such that the images that are located adjacent to each other on the screen partly overlap each other.

15. The image projection system according to claim 1, wherein the plurality of projection units are arranged such that the images that are projected on the screen by the projection units are shifted by half of a pixel pitch from each other.

16. The image projection system according to claim 1, wherein the calibration data includes color correction data and/or geometric correction data of the images that are projected on the screen by the projection units.

17. A calibration data calculation method in the image projection system according to claim 1, comprising:
displaying a calibration pattern image by the display unit;
turning on the light sources in accordance with each of the predetermined combinations of light sources;
acquiring information relating to colors and/or geometry of the calibration pattern image that is projected on the screen by the projection unit in accordance with each of the predetermined combinations of light sources; and
calculating the calibration data in accordance with each of the predetermined combinations of light sources on the basis of the acquired information.

18. A calibration data calculation method in the image projection system according to claim 1, comprising:
displaying a calibration pattern image by the display unit;
turning on the light sources in accordance with each of specified combinations of light sources, in which the number of light sources to be turned on in each of the projection units is one;
acquiring information relating to colors and/or geometry of the calibration pattern image that is projected on the screen by the projection unit in accordance with each of the specified combinations of light sources;
calculating the calibration data in accordance with each of the specified combinations of light sources on the basis of the acquired information; and
calculating, using the calculated calibration data, calibration data with respect to the predetermined combinations other than the specified combinations.
